(19) United States
(12) Patent Application Publication
(10) Pub. No.: US 2009/0007020 A1
(43) Pub. Date: Jan. 1, 2009

(54) IMAGE DISPLAY DEVICE, IMAGE PICKUP APPARATUS, IMAGE DISPLAY METHOD, AND PROGRAM THEREOF

(75) Inventors: Yasufumi SUZUKI, Tokyo (JP); Ryo Ochi, Kanagawa (JP); Nobuki Furue, Tokyo (JP); Tetsuhisa Araki, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/131,357

(22) Filed: Jun. 2, 2008

(30) Foreign Application Priority Data
Jun. 28, 2007 (JP) 2007-171247

(51) Int. Cl. G06F 3/048

(52) U.S. Cl. 715/841

(57) ABSTRACT

An image display device includes a display unit configured to display at least an image and an icon representing a predetermined setting, an operation input unit configured to perform an operation input, and a control unit configured to cause, if the icon displayed on the display unit is selected by using the operation input unit, a predetermined sub-menu used to select a setting related to the icon to be displayed on the display unit and to allow a desired setting item to be selected from the sub-menu.

### CROSS REFERENCES TO RELATED APPLICATIONS

The present invention contains subject matter related to Japanese Patent Application JP 2007-171247 filed in the Japanese Patent Office on Jun. 28, 2007, the entire contents of which are incorporated herein by reference.

### BACKGROUND OF THE INVENTION

1. Field of the Invention

The present invention relates to, for example, an image display device, and in particular, to an image display device, an image pickup apparatus, an image display method, and a program thereof that allow setting of various settings utilizing icons displayed on a screen.

2. Description of the Related Art

Image pickup apparatuses such as digital still cameras or digital video cameras have a liquid crystal panel such as a liquid crystal display (LCD). Thus, a user can achieve a desired composition by observing an image displayed on the liquid crystal panel (that is, a through-the-lens image), and take a picture or a video. Moreover, not only the taken picture or video but also icons representing various settings can be displayed on the liquid crystal panel.

In addition, recently, image pickup apparatuses with operation input means such as a touch panel have been developed. In the case of one such image pickup apparatus, a touch panel is superimposed on the liquid crystal panel, whereby the touch panel and the liquid crystal panel function as a touch screen. When an image pickup apparatus with such a structure is used, a user can perform a predetermined operation input by tapping an icon displayed on the touch screen.

Regarding this type of technology, for example, in Japanese Unexamined Patent Application Publication No. 2002-196667, there is disclosed an image pickup apparatus. The image pickup apparatus has a touch panel provided on a display panel and various operation buttons are observed via the touch panel. Certain functions corresponding to the operation buttons are performed by operating the various operation buttons via the touch panel. The various operation buttons include an automatic-mode button, a menu button, a flash button, a timer button, a macro-mode button, a screen-size setting button, and the like.

### SUMMARY OF THE INVENTION

In an example of the related art, icons displayed on the touch screen are used to indicate states of various settings. In the example, the settings represented by the icons are not changed by directly performing operation inputs by selecting the icons via the touch panel.

That is, in order to change the settings represented by the icons, it has been necessary to cause data on a setting screen to be read out by operating, for example, an additionally provided operation button, cause the setting screen to be displayed on a liquid crystal panel, select a desired setting from the setting screen, and perform an operation input for the desired setting.

Thus, it is desirable to allow a direct operation input to be performed by selecting an icon displayed on a screen without the necessity of operating, for example, an additionally provided operation button, to enable, for example, a setting related to the icon to be simply and quickly set and changing of the setting to be simply and quickly performed, and to improve the convenience of users.

According to an embodiment of the present invention, there is provided an image display device including display means for displaying at least an image and an icon representing a predetermined setting, operation input means for performing an operation input, and control means for causing, if the icon displayed on the display means is selected by using the operation input means, a predetermined sub-menu used to select a setting related to the icon to be displayed on the display means and for allowing a desired setting item to be selected from the sub-menu.

Thus, the sub-menu used to select the setting related to the icon is displayed by directly selecting the icon by using the operation input means.

The operation input means may be a touch panel, and if the icon is directly selected by pressing the touch panel at a position, the position corresponding to a position of the icon displayed on the display means, the control means may detect the selecting of the icon and cause the sub-menu relating to the icon to be displayed on the display means.

According to another embodiment of the present invention, there is provided an image pickup apparatus including image pickup means for capturing a subject image and obtaining an image signal, display means for displaying at least a captured image based on the image signal obtained from the image pickup means and an icon representing a predetermined setting, operation input means for performing an operation input, and control means for causing, if the icon displayed on the display means is selected by using the operation input means, a predetermined sub-menu used to select a setting related to the icon to be displayed on the display means and allowing a desired setting item to be selected from the sub-menu.

Thus, the sub-menu used to select the setting related to the icon is displayed by directly selecting the icon by using the operation input means, thereby enabling various settings relating to, for example, an image pickup operation to be set.

The operation input means may be a touch panel, and the control means may detect, if the icon is directly selected by pressing the touch panel at a position, the position corresponding to a position of the icon displayed on the display means, the selecting of the icon and cause the sub-menu relating to the icon to be displayed on the display means.

According to another embodiment of the present invention, there is provided an image display method including the steps of displaying an icon representing a setting on display means, displaying, if the icon is selected by using operation input means, a predetermined sub-menu used to select a setting related to the icon on the display means, and allowing a desired setting item to be selected from the sub-menu.

Thus, the sub-menu used to select the setting related to the icon is displayed by directly selecting the icon.

According to another embodiment of the present invention, there is provided a program performed by a computer. The program includes the steps of causing a computer to function as icon display means for displaying, on display means, an icon representing a setting, causing, if the icon is selected by using operation input means, the computer to function as sub-menu display means for displaying, on the display means, a predetermined sub-menu used to select a setting related to the icon, and causing the computer to function as main control means for allowing a desired setting item to be selected from the sub-menu.

Thus, according to software processing based on the program, the sub-menu used to select the setting related to the icon is displayed by directly selecting the icon displayed on the screen, thereby enabling the setting related to the icon and the like to be set.

According to the embodiments of the present invention, there are provided an image display device, an image pickup apparatus, an image display method, and a program that allow a direct operation input to be performed by selecting an icon displayed on a screen without the necessity of operating, for example, an additionally provided operation button, and enable, for example, a setting related to the icon to be simply and quickly set and changing of the setting to be simply and quickly performed. Thus, the convenience of users is improved.

### BRIEF DESCRIPTION OF THE DRAWINGS

FIG. 1 is a schematic diagram of an image display device according to a first embodiment of the present invention;

FIG. 2 is a block diagram showing a structure of an image pickup apparatus according to a second embodiment of the present invention;

FIG. 3A is a front-side perspective view of the image pickup apparatus according to the second embodiment of the present invention;

FIG. 3B is a back-side perspective view of the image pickup apparatus according to the second embodiment of the present invention;

FIG. 4 is a flowchart showing, in detail, characteristic processing performed by the image pickup apparatus according to the second embodiment of the present invention;

FIG. 5 is an exemplary operation screen of the image pickup apparatus according to the second embodiment of the present invention;

FIG. 6 is an exemplary screen displayed on a touch screen, the exemplary screen relating to changing an image size;

FIG. 7 is an exemplary screen displayed on the touch screen, the exemplary screen relating to a macro shooting setting;

FIG. 8 is an exemplary screen displayed on the touch screen, the exemplary screen relating to changing a camera mode; and

FIG. 9 is an exemplary screen displayed on the touch screen, the exemplary screen relating to an AF setting.

### DESCRIPTION OF THE PREFERRED EMBODIMENTS

Embodiments of the present invention will be described in detail with reference to the attached drawings.

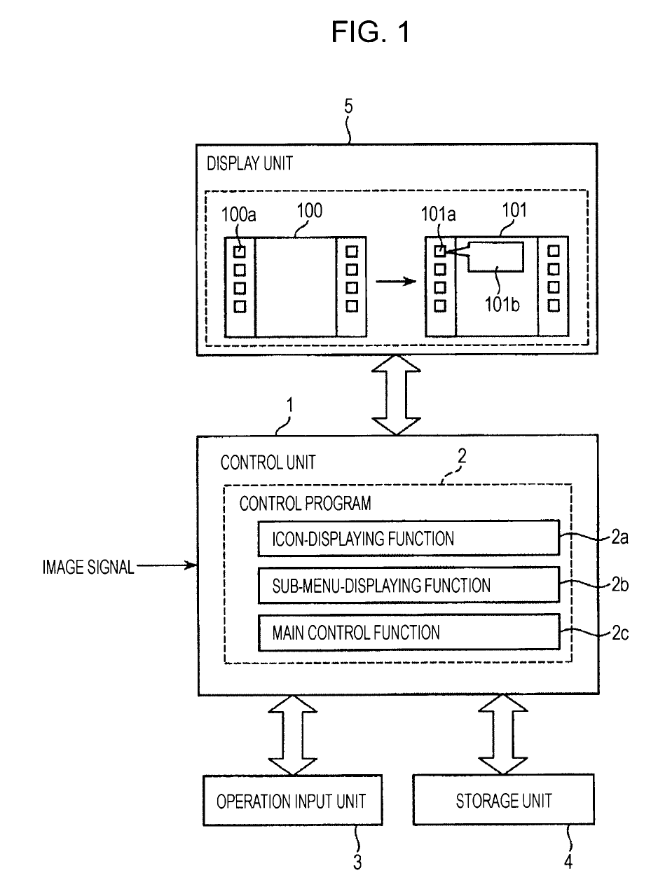

FIG. 1 shows the structure of an image display device according to a first embodiment of the present invention.

As shown in FIG. 1, the image display device includes a control unit 1 that controls the entirety of the image display device, an operation input unit 3, a storage unit 4, and a display unit 5. The control unit 1 reads out a control program 2 prestored in the storage unit 4, and executes the control program 2, whereby at least an icon-displaying function 2a, a sub-menu-displaying function 2b, and a main control function 2c are performed.

When the control unit 1 performs the functions 2a through 2c, the control unit 1 functions as, for example, icon-displaying means, sub-menu-displaying means, and main control means.

With such a structure, the control unit 1 causes a predetermined operation screen 100 to be displayed on the display unit 5 by means of the main control function 2c. The control unit 1 also causes a plurality of icons 100a representing various settings to be displayed on the display unit 5 by means of the icon-displaying function 2a. If a user operates the operation input unit 3, which is for example a touch panel, and one of the icons 100a is selected, the control unit 1 causes, by means of the sub-menu-displaying function 2b, a sub-menu 101b to be displayed in a manner such that the sub-menu 101b is visually related to the selected icon 101a on an operation screen 101, and allows the user to select a desired setting from the sub-menu 101b. Thus, if the user operates the operation input unit 3 and selects a desired setting from the sub-menu 101b, the control unit 1 switches, by means of the main control function 2c, the setting represented by the selected icon 101a to the desired setting. Then, displaying of the sub-menu 101b is stopped and the predetermined operation screen 100 is again displayed on the display unit 5.

In this way, the image display device according to the first embodiment of the present invention can perform a series of characteristic processes described below.

First, an operation input can be directly performed by selecting an icon displayed on an operation screen.

Next, if the above-mentioned operation input is performed, a sub-menu used to select a setting related to the icon can be displayed.

Then, a desired setting can be selected from the sub-menu.

Therefore, unlike an existing way, if an operation input is directly performed by selecting an icon displayed on an operation screen, without the necessity of operating an additionally provided operation button and causing data on a setting screen to be read out, a sub-menu used to select a setting of a function indicated by the icon is displayed. Thus, by just selecting a desired setting from among settings displayed on the sub-menu, the user can simply, quickly, and precisely change (update) a current setting to the desired setting. That is, compared with the example in the related art, a step of operating the additionally provided operation button is omitted.

This not only simplifies setting operations performed by the user, but also directly leads the user in setting a setting represented by a desired icon, whereby an operating error and a setting error can be prevented.

Next, a second embodiment of the present invention will be described.

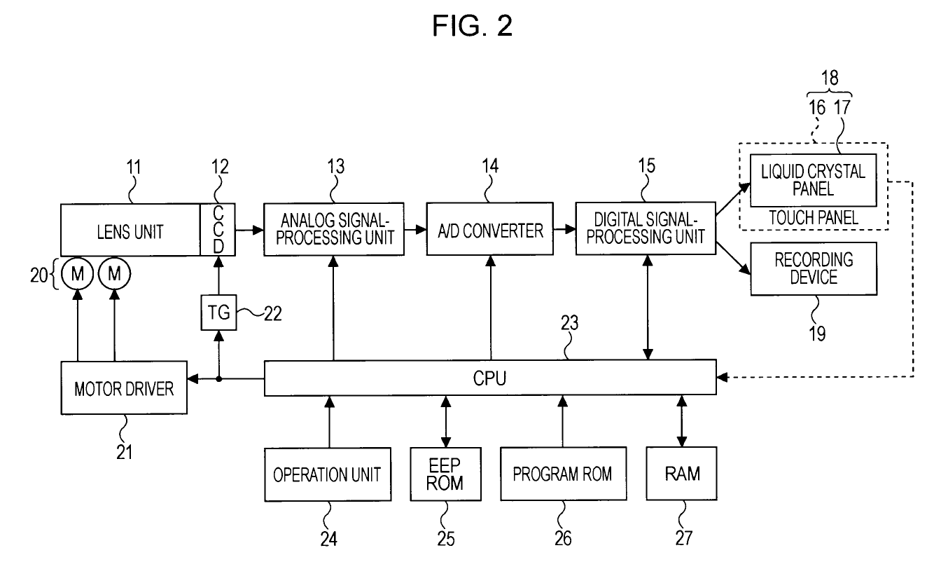

FIG. 2 shows the structure of an image pickup apparatus according to the second embodiment of the present invention.

The image pickup apparatus according to the second embodiment of the present invention is an image pickup apparatus, which is for example a digital still camera or a digital video camera, to which the image display device according to the first embodiment of the present invention is applied. Details thereof will be described below.

As shown in FIG. 2, the image pickup apparatus according to the second embodiment of the present invention includes a lens unit 11, which includes, for example, a shooting lens, an aperture, and a focus lens. An image pickup device 12 such as a charge-coupled device (CCD) is disposed in an optical path of subject-image light entering via the lens unit 11. The image pickup device 12, an analog signal processing unit 13, an analog-to-digital (A/D) converter 14, and a digital signal processing unit 15 are connected in series. An output of the digital signal processing unit 15 is electrically connected to an input of a liquid crystal panel 17 and to an input of a recording device 19.

An actuator 20 that adjusts the size of the aperture or moves the focus lens is mechanically connected to the lens unit 11, the aperture and the focus lens being included in the lens unit 11. The actuator 20 is connected to a motor driver 21 that performs drive control of the actuator 20.

Moreover, a central processing unit (CPU) 23 that controls the entirety of the image pickup apparatus is provided therein. The CPU 23 is connected to the motor driver 21, a timing generator (TG) 22, an operation unit 24, an electrically erasable programmable read-only memory (EEPROM) 25, a program ROM 26, a random access memory (RAM) 27, and a touch panel 16. The CPU 23 functions as control means, especially as icon-displaying means, sub-menu-displaying means, main control means, and the like by reading out and executing the control program stored in the program ROM 26.

The touch panel 16 and the liquid crystal panel 17 constitute a touch screen 18.

The recording device 19 may be, for example, a disc such as a digital versatile disc (DVD), a semiconductor memory such as a memory card, or a removable recording medium other than those mentioned earlier. The recording device 19 is removable from the body of the image pickup apparatus. The EEPROM 25 stores, for example, various data on the settings and other data that are necessity of being stored while the power is off. The program ROM 26 stores a program to be executed by the CPU 23 and certain data necessary when executing the program. The RAM 27 serving as a work area temporarily stores a necessary program or data when the CPU 23 executes various processing.

With such a structure, the CPU 23 controls units constituting the image pickup apparatus by executing the program stored in the program ROM 26, and executes predetermined processing in response to a signal input from the touch panel 16 or a signal input from the operation unit 24. The operation unit 24 is operated by the user, and supplies, to the CPU 23, a signal in response to the user's operation.

If the touch panel 16 is pressed, for example, by a finger at an arbitrary position (that is, if a user performs a predetermined operation input), the touch panel 16 detects the coordinates of the pressed position, and sends a signal relating to the coordinates to the CPU 23. The CPU 23 obtains certain information regarding the coordinates, and executes certain processing on the basis of the obtained information.

When the subject-image light enters the image pickup device 12 via the lens unit 11, the image pickup device 12 captures the subject-image light, converts the subject-image light into an analog image signal, and outputs the analog image signal. Here, the motor driver 21 drives the actuator 20 on the basis of the control performed by the CPU 23. This driving causes the lens unit 11 to be exposed to the outside or to be stored in the casing of the image pickup apparatus. This driving also causes the aperture of the lens unit 11 to be adjusted or the focus lens included in the lens unit 11 to be moved.

Furthermore, the TG 22 supplies a timing signal to the image pickup device 12 on the basis of the control performed by the CPU 23. This timing signal is used to control, for example, an exposure time for the image pickup device 12. The image pickup device 12 is operated on the basis of the timing signal supplied from the TG 22. This causes the image pickup device 12 to convert the received subject-image light entering via the lens unit 11 into an analog image signal, which is an electric signal whose amplitude varies in response to the amount of the light received, and supply the analog image signal to the analog signal processing unit 13. The analog signal processing unit 13 performs, on the basis of the control performed by the CPU 23, analog signal processing (for example, amplification) on the analog image signal supplied from the image pickup device 12, and supplies a resulting image signal to the A/D converter 14.

The A/D converter 14 converts, on the basis of the control performed by the CPU 23, the analog image signal supplied from the analog signal processing unit 13 into digital image data, and supplies the digital image data to the digital signal processing unit 15. The digital signal processing unit 15 performs digital signal processing such as noise reduction processing on the digital image data supplied from the A/D converter 14, supplies the resulting digital image data to the liquid crystal panel 17, and causes an image represented by the resulting digital image data to be displayed on the liquid crystal panel 17 on the basis of the control performed by the CPU 23.

The digital signal processing unit 15 performs compression processing, for example, in accordance with the joint photographic experts group (JPEG) scheme, on the digital image data supplied from the A/D converter 14, supplies the resulting compressed digital image data to the recording device 19, and causes the resulting compressed digital image data to be recorded in the recording device 19.

Moreover, the digital signal processing unit 15 performs decompression processing on the compressed image data recorded in the recording device 19, supplies the resulting image data to the liquid crystal panel 17, and causes an image represented by the resulting image data to be displayed on the liquid crystal panel 17. That is, the digital signal processing unit 15 supplies, to the liquid crystal panel 17, the image data supplied from the A/D converter 14, and an image represented by the image data is displayed on the liquid crystal panel 17 as the through-the-lens image. Furthermore, the digital signal processing unit 15 generates, on the basis of the control performed by the CPU 23, a focus frame (an autofocus (AF) frame) used to control the focus, supplies the focus frame to the liquid crystal panel 17, and causes the focus frame to be displayed on the liquid crystal panel 17.

Then, if a user presses a shutter button included in the operation unit 24, the operation unit 24 supplies a release signal to the CPU 23. If such a release signal is supplied to the CPU 23 in this way, the CPU 23 controls the digital signal processing unit 15, so that the image data supplied from the A/D converter 14 to the digital signal processing unit 15 is compressed and the compressed image data is recorded in the recording device 19.

The image pickup apparatus has an AF function. In the first embodiment of the present invention, the AF frame is set on an image captured by the image pickup device 12, and the focus of the lens unit 11 is controlled on the basis of the image within the AF frame. This AF function allows the AF frame to be set at an arbitrary position on the image displayed on the liquid crystal panel 17. Moreover, for example, the position of and the size of the AF frame can be controlled by just operating the touch panel 16 integrally provided with the liquid crystal panel 17. The AF processing is achieved if the CPU 23 reads and executes a program stored in the program ROM 26.

A characteristic point of the first embodiment of the present invention will be described below. That is, the CPU 23 causes a predetermined operation screen and icons representing various settings to be displayed on the liquid crystal panel 17 by reading and executing the control program stored in the program ROM 26. If a user operates the touch panel 16 and one of the icons is tapped and selected, the CPU 23 causes a sub-menu to be displayed in a manner such that the sub-menu is visually related to the selected icon, and allows the user to select a desired setting from the sub-menu. In this way, if a user operates the touch panel 16 and a desired setting is tapped and selected from the sub-menu, the CPU 23 switches the current setting represented by the icon to the desired setting. Then, displaying of the sub-menu is stopped, and the predetermined operation screen is displayed on the liquid crystal panel 17 again.

According to the above-described processing, a direct operation input performed by selecting an icon displayed on an operation screen causes a sub-menu used to select a setting of a function indicated by the icon to be displayed. Thus, by selecting a desired setting from among settings displayed on the sub-menu, the user can simply, quickly, and accurately change (update) a current setting to the desired setting.

This not only causes setting operations performed by a user to be simplified, but also prevents an operation error or a setting error.

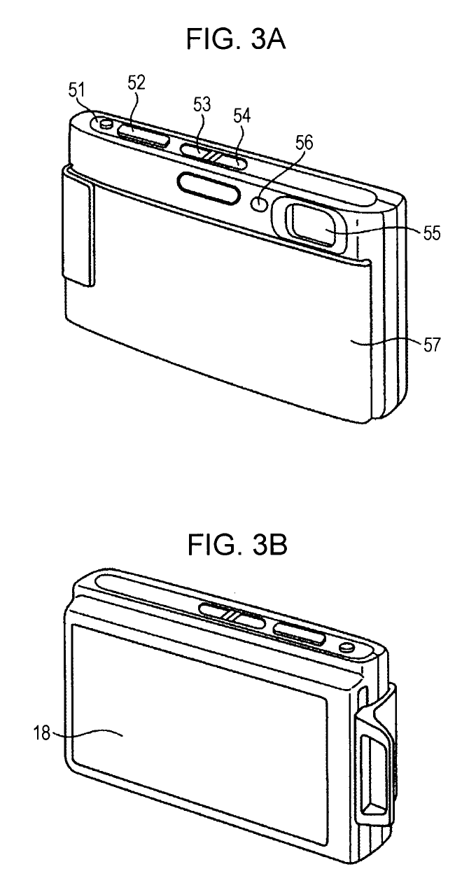

FIGS. 3A and 3B show external views of an image pickup apparatus according to a second embodiment of the present invention.

FIG. 3A shows a front-side perspective view of the image pickup apparatus, and FIG. 3B shows a back-side perspective view of the image pickup apparatus.

A lens cover 57 is provided on the front side of the image pickup apparatus. A shooting lens 55, which is included in the lens unit 11, and an AF illuminator 56 are arranged to be exposed to the outside when the lens cover 57 is slid down. The AF illuminator 56 also functions as a self-timer lamp. A zoom lever (TELE/WIDE) 51, a shutter button 52, a playback button 53, and a power button 54 are provided on the top surface of the image pickup apparatus. The touch screen 18 is provided at the back side of the image pickup apparatus. The zoom lever 51, the shutter button 52, the playback button 53, and the power button 54 are included in the operation unit 24.

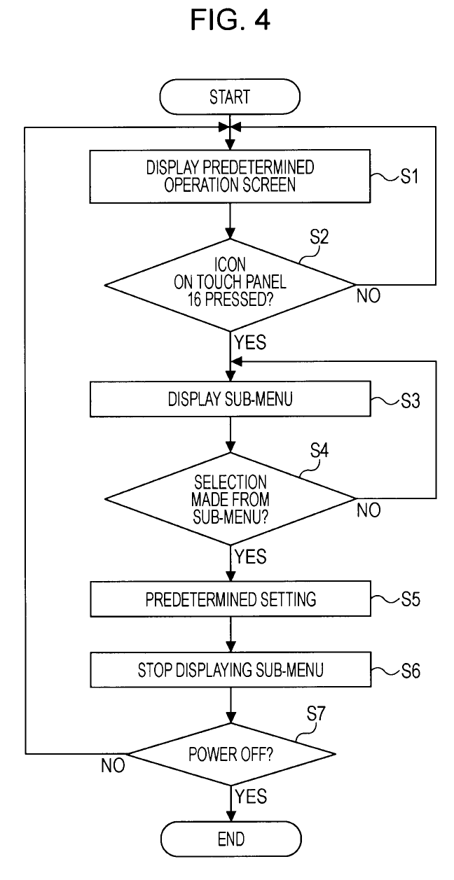

Characteristic processing performed by the image pickup apparatus according to the second embodiment of the present invention will be specifically described below with reference to a flowchart shown in FIG. 4. The following series of processes also corresponds to an image display method according to the second embodiment of the present invention.

The series of processes is started by, for example, turning on power. In step S1, the CPU 23 causes the liquid crystal panel 17 to display a predetermined operation screen. In step S2, the CPU 23 determines whether a user has selected an icon displayed on the operation screen by performing an operation input via the touch panel 16.

If the icon has not been tapped (“No” in step S2), the flow returns to step S1 and the above-described processing is repeated. If the icon has been tapped (“Yes” in step S2), in step S3, the CPU 23 causes the liquid crystal panel 17 to display a sub-menu relating to the icon. In step S4, the CPU 23 determines whether one of setting items has been selected from the sub-menu by tapping an arbitrary position on the touch panel 16. If it is determined that no setting item has been selected (“No” in step S4), the flow returns to step S3 and the above-described processing is repeated.

If it is determined that the touch panel 16 is tapped and one of the setting items has been selected from the sub-menu (“Yes” in step S4), the flow proceeds to step S5. In step S5, the CPU 23 sets or updates the setting. In step S6, the CPU 23 stops displaying the sub-menu. In step S7, the CPU 23 determines whether the power has been turned off. If the CPU 23 determines that the power has not been turned off (“No” in step S7), the flow returns to step S1, and the above-described processing is repeated. Otherwise (“Yes” in step S7), the series of the processes is complete.

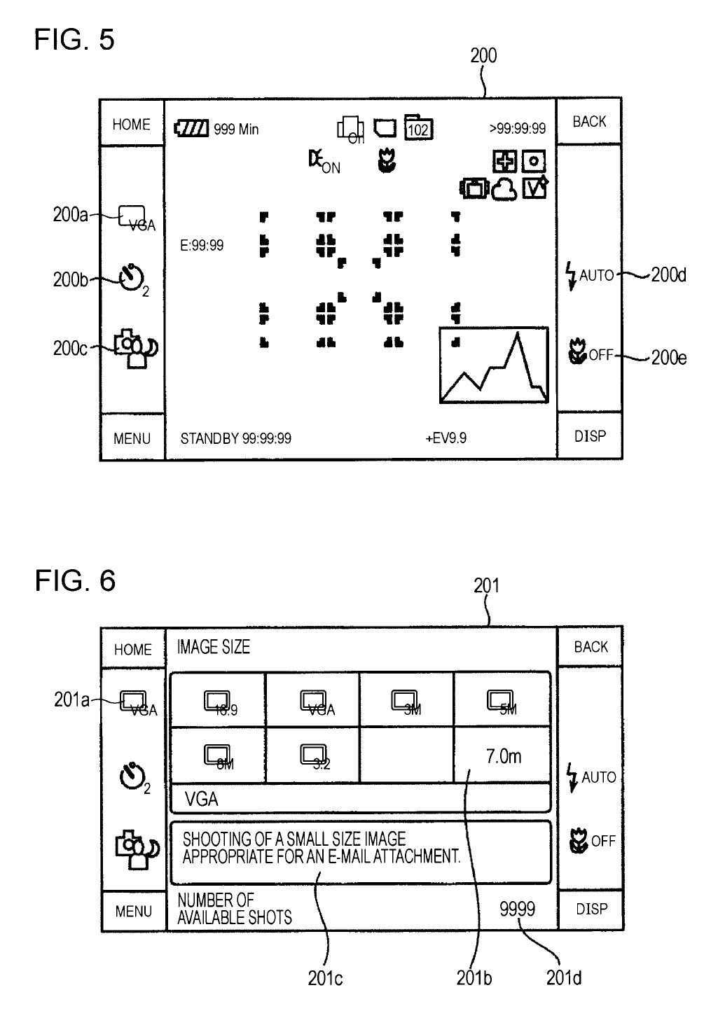

According to the above-described processing, if one of icons is selected through an initial operation screen 200 shown in FIG. 5, a predetermined sub-menu is displayed, and a specific setting can be set.

Icons 200a though 200e are displayed on the operation screen 200 shown in FIG. 5. The icons 200a though 200e will be briefly described below.

The icon 200a is an icon representing the image size setting. In particular, for the size of a still image, selection can be made from among 8 M (3264×2448 pixels), 3:2 (3264×2176 pixels), 5 M (2592×1944 pixels), 3 M (2048×1536 pixels), VGA (640×480 pixels), 16:9 (1920×1080 pixels) and the like.

The icon 200b is an icon representing the self-timer setting.

The icon 200c is an icon representing the shooting-mode setting. The icon 200d is an icon representing the flash-mode setting. The icon 200e is an icon representing the macro/super-macro setting. For brevity, only the icons 200a through 200e are illustrated; however, it is obvious that icons are not limited to the illustrated icons 200a through 200e.

Here, an icon (not shown) relating to selecting a video size may be displayed at the position of the icon 200a. If the icon relating to selecting a video size is displayed, for the size of a video, selection can be made from among the “fine” size (640×480 pixels, about thirty frames per second (fps)), the “standard” size (640×480 pixels, about seventeen fps), the “presentation” size (320×240 pixels, about eight fps), and the like.

If, for example, the icon 200a representing the still-image size setting is tapped and selected on the operation screen 200 shown in FIG. 5, a sub-menu 201b is displayed on a screen 201 as shown in FIG. 6, and a desired size can be set as the image size from among the image sizes mentioned above.

That is, on the screen 201 shown in FIG. 6, the sub-menu 201b is displayed in a manner such that the sub-menu 201b is visually related to an icon 201a, and buttons (“8 M”, “3:2”, “5 M”, “3 M”, “VGA”, and “16:9”) indicating still-image sizes are displayed in a selectable manner in the sub-menu 201b. If one of the buttons is tapped and selected on the touch panel 16, a description relating to the selected button is displayed in an area 201c. For example, a description relating to “VGA” is displayed as “shooting of a small size image appropriate for an e-mail attachment”. In addition, the number of available shots in the case of the selected size is displayed in an area 201d. Here, as an example, “9999” is displayed as the number of available shots in the case of “VGA”.

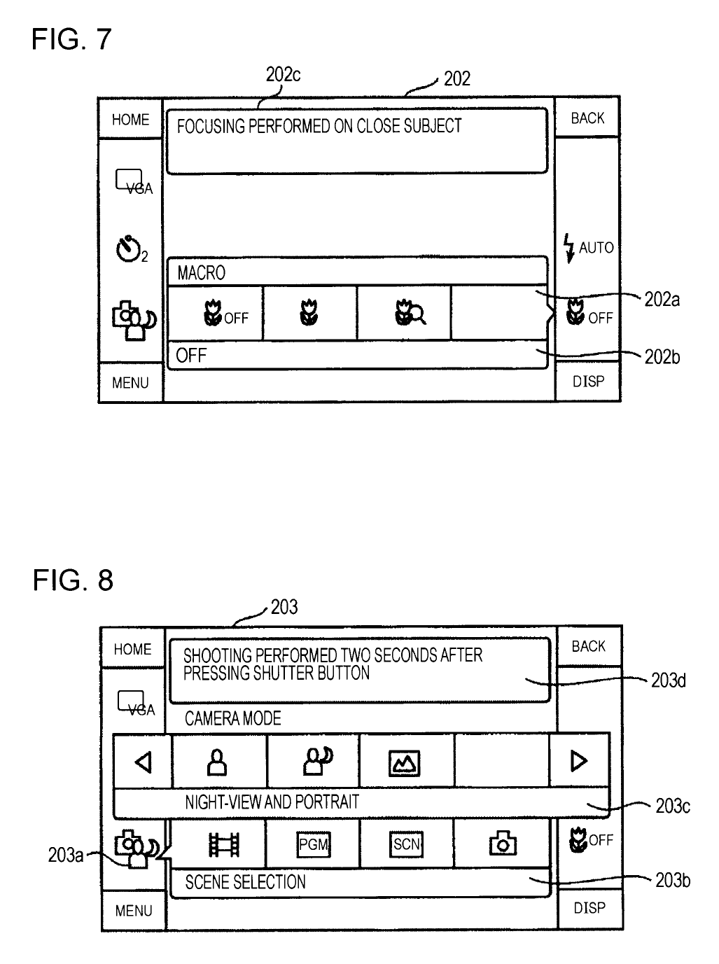

If, for example, the icon 200e representing the macro/super-macro setting is tapped and selected on the operation screen 200 shown in FIG. 5, a sub-menu 202b is displayed on a screen 202 as shown in FIG. 7, and one of macro shooting (OFF), macro shooting, and super-macro shooting can be set.

That is, the sub-menu 202b is displayed in a manner such that the sub-menu 202b is visually related to an icon 202a on the screen 202 shown in FIG. 7, and buttons allowing selection of the macro shooting (OFF), the macro shooting, and the super-macro shooting are displayed in a selectable manner in the sub-menu 202b. Moreover, a description relating to a selected button is displayed in an area 202c. Here, as an example, “focusing performed on close subject” is displayed as the description relating to the macro shooting (OFF).

If, for example, the icon 200c representing the shooting mode setting is selected on the operation screen 200 shown in FIG. 5, a sub-menu 203c is displayed on a screen 203 as shown in FIG. 8, and one of action shooting (action shooting with sound), program auto shooting, scene selection (SCN) shooting (shooting in a setting matching the shooting situation), and the like can be set.

That is, a sub-menu 203b is displayed in a manner such that the sub-menu 203b is visually related to an icon 203a on the screen 203 shown in FIG. 8, and a sub-menu 203c relating to a button selected in the sub-menu 203b is also displayed. Here, an example in which the SCN shooting has been selected in the sub-menu 203b is illustrated. As detailed settings for the SCN shooting, buttons allowing selection of a soft snap mode, a night-view and portrait mode, a landscape mode, and a night view mode are displayed in the sub-menu 203c in a selectable manner. Moreover, a description relating to a selected button is displayed in an area 203d. Here, as an example, “shooting performed two seconds after pressing shutter button” is displayed as the description relating to the night-view and portrait mode.

Icons are not displayed in a bottom area of the operation screen 200 shown in FIG. 5; however, icons may be displayed in the bottom area in some modes.

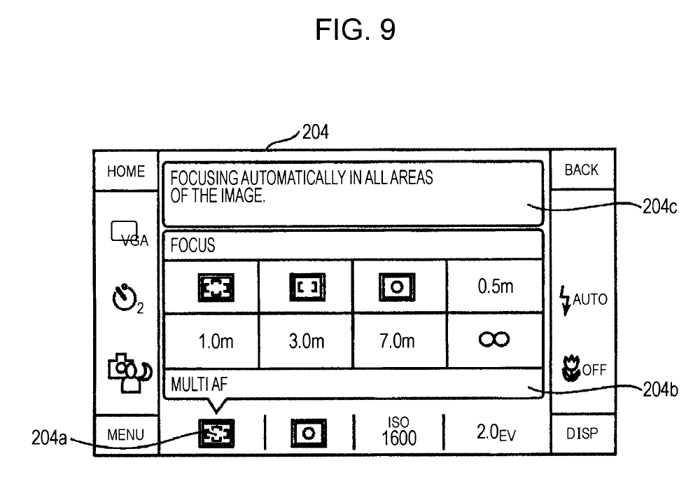

As an example, as shown in FIG. 9, if an icon 204a displayed in a bottom area of a screen 204 is tapped and selected, a sub-menu 204b is displayed, and selection can be made from among, for example, a multi AF mode (focusing automatically in all areas of an image displayed on the screen), a center AF mode (focusing automatically on a subject in the center or near the center of the image displayed on the screen), a spot AF mode (moving the AF frame to wherever a user likes on the screen, and focusing on a subject in the AF frame automatically), and an infinity mode (the focus being fixed at a pre-set distance). Buttons corresponding to these modes are displayed in a selectable manner in the sub-menu 204b. In this case, a description relating to a selected button is also displayed in an area 204c. As an example, “focusing automatically in all areas of the image” is displayed as the description relating to the multi AF mode.

In this way, according to the second embodiment of the present invention, if an icon displayed on the liquid crystal panel 17 at a certain position is selected by tapping the touch panel 16 at the certain position, the touch panel 16 being provided on the liquid crystal panel 17, a sub-menu used to select a setting related to the icon is quickly displayed. A desired setting can be selected by simply tapping a button representing the desired setting from among buttons provided in the sub-menu.

With regard to this point, in the case of the existing devices, it has been necessary to tap an additionally provided setting button first to cause a setting menu to be displayed, and select a desired setting item from among setting items in the setting menu in order to set a setting. However, in the case of the image pickup apparatus according to the second embodiment of the present invention, direct selection of an icon immediately allows a user to set a setting related to the icon. Therefore, the convenience of users can be improved, and an operation error and an input error can be prevented.

The quick setting and changing of settings have been desired since users who are not used to operate image pickup apparatuses such as digital cameras have great difficulty in causing even a setting menu to be displayed. In the image pickup apparatus according to the second embodiment of the present invention, a description for the sub-menu is provided in response to displaying of the sub-menu in an area specified for the description, and thus a setting can be set more quickly and more precisely and the setting can be changed or updated more quickly and precisely.

As described above, according to the first embodiment and the second embodiment of the present invention, an image display device, an image pickup apparatus, an image displaying method, and a program thereof can be provided that, when an operation input is directly performed by selecting an icon displayed on the operation screen causing a sub-menu to be displayed, simply, quickly, and precisely allow a current setting to be changed to a desired setting by just allowing a user to select the desired setting from the setting items displayed in the sub-menu.

The present invention has been described with reference to the above embodiments; however, the present invention is not limited thereto, and it should be understood by those skilled in the art that various modifications, combinations, sub-combinations and alterations may occur depending on design requirements and other factors insofar as they are within the scope of the appended claims or the equivalents thereof.

For example, when an icon is selected (pressed) and a sub-menu is displayed, selection-history data of a user is recorded. The displaying order of setting items displayed in the sub-menu may be changed in response to selection frequency obtained from the recorded selection-history data of the user. Alternatively, when the sub-menu is displayed, a setting with a high priority in terms of other settings may be displayed, for example, in a different color in order to allow a user to preferentially select the setting with a high priority.

What is claimed is:

1. An image display device comprising:
display means for displaying at least an image and an icon representing a predetermined setting;
operation input means for performing an operation input; and
control means for causing, if the icon displayed on the display means is selected by using the operation input means, a predetermined sub-menu used to select a setting related to the icon to be displayed on the display means and for allowing a desired setting item to be selected from the sub-menu.

2. The image display device according to claim 1,
wherein the operation input means is a touch panel, and
if the icon is directly selected by pressing the touch panel at a position, the position corresponding to a position of the icon displayed on the display means, the control means detects the selecting of the icon and causes the sub-menu relating to the icon to be displayed on the display means.

3. An image pickup apparatus comprising:
image pickup means for capturing a subject image and obtaining an image signal;
display means for displaying at least a captured image based on the image signal obtained from the image pickup means and an icon representing a predetermined setting;
operation input means for performing an operation input; and
control means for causing, if the icon displayed on the display means is selected by using the operation input means, a predetermined sub-menu used to select a setting related to the icon to be displayed on the display means and allowing a desired setting item to be selected from the sub-menu.

4. The image pickup apparatus according to claim 3,
wherein the operation input means is a touch panel, and
the control means detects, if the icon is directly selected by pressing the touch panel at a position, the position corresponding to a position of the icon displayed on the display means, the selecting of the icon and causes the sub-menu relating to the icon to be displayed on the display means.

5. An image display method comprising the steps of:
displaying an icon representing a setting on display means;
displaying, if the icon is selected by using operation input means, a predetermined sub-menu used to select a setting related to the icon on the display means; and
allowing a desired setting item to be selected from the sub-menu.

6. A program performed by a computer, the program comprising the steps of:
causing a computer to function as icon display means for displaying, on display means, an icon representing a setting;
causing, if the icon is selected by using operation input means, the computer to function as sub-menu display means for displaying, on the display means, a predetermined sub-menu used to select a setting related to the icon; and
causing the computer to function as main control means for allowing a desired setting item to be selected from the sub-menu.

7. An image display device comprising:
a display unit configured to display at least an image and an icon representing a predetermined setting;
an operation input unit configured to perform an operation input; and
a control unit configured to cause, if the icon displayed on the display unit is selected by using the operation input unit, a predetermined sub-menu used to select a setting related to the icon to be displayed on the display unit and to allow a desired setting item to be selected from the sub-menu.

8. An image pickup apparatus comprising:
an image pickup unit configured to capture a subject image and obtain an image signal;
a display unit configured to display at least a captured image based on the image signal obtained from the image pickup unit and an icon representing a predetermined setting;
an operation input unit configured to perform an operation input; and
a control unit configured to cause, if the icon displayed on the display unit is selected by using the operation input unit, a predetermined sub-menu used to select a setting related to the icon to be displayed on the display unit and to allow a desired setting item to be selected from the sub-menu.
